(19) United States
(12) Patent Application Publication
(10) Pub. No.: US 2002/0127470 A1
(43) Pub. Date: Sep. 12, 2002

(54) Independent seal and vent for an electrochemical cell

(76) Inventors: Marc L. Syvertsen, Madison, WI (US); Viet H. Vu, Verona, WI (US); Bruce Weldum, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/093,776

(22) Filed: Mar. 7, 2002

Related U.S. Application Data
(60) Provisional application No. 60/273,804, filed on Mar. 7, 2001.

(51) Int. Cl. H01M 2/08; H01M 2/12

(52) U.S. Cl. 429/174; 429/53; 429/164

(57) ABSTRACT

An electrochemical cell is presented having a first component that provides a seal to prevent the escape of internal cell ingredients from the battery and into the ambient environment during normal operation of the cell. A second component, independent of the first component, provides a vent and allows built-up pressure to dissipate when the pressure reaches a predetermined maximum threshold.

### CROSS-REFERENCE TO RELATED APPLICATIONS

The present application claims priority to provisional patent application number 60/273,804, filed Mar. 7, 2001, and entitled “Seal and Vent Combination for an Electrochemical Cell” the disclosure of which is hereby incorporated by reference as if set forth in its entirety herein.

### BACKGROUND OF THE INVENTION

1. Field of the Invention

The present invention relates generally to electrochemical cells, and in particular, relates to an apparatus for sealing and venting an electrochemical cell.

2. Description of the Related Art

Conventional electrochemical cells, such as alkaline cells, comprise a cathode, typically graphite, compressed into annular rings that is often wetted with an alkaline electrolyte. The cathode is then placed into a metal container which then serves as the positive current collector. A separator is typically disposed radially inwardly of the cathode and separates the cathode from the anode, which generally comprises a powdered zinc disposed in a gel, such as carboxymethylcellulose. The negative current collector, usually a brass pin or nail, is placed in electrical contact with the anode.

Such cells typically include a seal that prevents the materials disposed within the cell from escaping at the interface between the negative endplate and the container. During normal use of the cell, the pressure within the cavity is sufficiently low, thereby presenting substantially no threat to the integrity of the cell structure. However, when the battery is misused, substantial pressure may build up within the cell. For example, if a user attempts to charge a non-chargeable cell, or exposes the cell to extreme heat, significant pressure may accumulate within the cell. If no means exists to dissipate the pressure, the battery could fail in an unpredictable manner. To prevent this occurrence, a vent is installed in the cell that remains closed until the pressure exceeds a threshold limit, at which time the vent will open, thereby permitting the pressure to dissipate from the cell and into the ambient environment. The vents of conventional cells have traditionally been constructed as a unitary member with the seal, and thus possess inherent drawbacks that will be now be described with reference to FIG. 1.

In particular, FIG. 1 illustrates a conventional cell including a unitary seal/vent member in the form of a gasket 10. Gasket 10 comprises an annular outer flange 14 that is seated in a ridge 11 formed within the inner surface of the container 13. The negative end of the cell is sealed by crimping the container 13 (and outer flange 14) over the endplate 16. Outer flange 14 is connected to an elongated neck 12 that is slid axially along the negative current collector and into place such that the outer flange 14 rests against the upper surface of 11. The neck 12 is connected to the outer flange via a radially extending disk having a breakaway section 19 of reduced thickness compared to the rest of the gasket 10. A washer 18 rests against the neck 12 and flange 14 to ensure that the outer flange 14 of gasket 10 remains in contact with the container, thereby maintaining the structural integrity of the cell. A first aperture 15 extends through the endplate 16, and a second aperture 17 extends through washer 18. When the internal cell pressure reaches a predetermined threshold, the breakaway section 19 will rupture, thereby allowing pressure to dissipate into the ambient environment via apertures 15 and 17.

Thus, the gasket 10 provides both a seal and a vent for the cell. Several drawbacks are associated with this conventional design. For example, the washer 18 must be manufactured within tight tolerance such that is has a large enough diameter to retain the gasket 10 in its proper position, but not so large so as to create additional stresses on the breakaway section 19 that could cause the gasket 10 to fail prematurely. Accordingly, because no significant force exists to bias the neck 12 against the current collector, the neck must extend along a substantial amount of the nail's length to produce an adequate seal that prevents the internal cell ingredients from escaping through the interface between the current collector and neck 12, and ultimately out aperture 15. The elongated neck 12 thus consumes valuable space within the cell that could otherwise be occupied by the anode mixture, thereby reducing the active volume of the cell and correspondingly reducing the life of the cell. Moreover, gasket 10 is required to have a high density and creep resistance in order to provide the necessary seal, however the breakaway section 19 must be adequately ductile so as to remain intact until the pressure buildup exceeds a predetermined amount. Furthermore, the thickness of breakaway section 19 must be manufactured within tight tolerance to ensure that it fails under predetermined conditions. Accordingly, conventional cells of this type are expensive and difficult to manufacture. Additionally, the internal volume located upstream of breakaway section 19 is vacant to allow adequate space for the rupture of section 19 such that the broken section 19 will not block aperture 17 during venting. This further reduces the active internal volume of the cell.

What is therefore needed is an electrochemical cell having an improved seal and vent mechanism that increases the usable internal volume of the cell cavity.

### BRIEF SUMMARY OF THE INVENTION

The present invention provides an electrochemical cell having a cylindrical container having an axially extending sidewall. A cathode is disposed within the sidewall and has an inner surface that defines a centrally disposed void. The void is filled with internal cell ingredients. An endplate is connected to the container, and defines an aperture extending therethrough. An ionically permeable separator is interposed between the cell ingredients and the cathode. A negative current collector is at least partially disposed within the void and electrically connected to the anode and has a distal end that is connected to the endplate. A compressed seal member is disposed between the endplate and container, wherein the seal prevents the cell ingredients from flowing therebetween. A vent member, separate from the seal member, provides a blockage to the aperture, and opens when an internal cell pressure has exceeded a predetermined threshold.

It is thus a general object of the invention to provide an electrochemical cell having a seal member separate from a vent member. The seal prevents leakage of internal cell ingredients into the ambient environment during normal operation, while the vent provides internal pressure dissipation once the internal cell pressure has exceeded a maximum permissible threshold. Advantageously, the seal and vent may be designed having properties that are compatible with their respective functions.

This and other aspects of the invention are not intended to define the scope of the invention for which purpose claims are provided. In the following description, reference is made to the accompanying drawings, which form a part hereof, and in which there is shown by way of illustration, and not limitation, preferred embodiments of the invention. Such embodiments do not define the scope of the invention and reference must be made therefore to the claims for this purpose.

### BRIEF DESCRIPTION OF THE DRAWINGS

Reference is hereby made to the following figures in which like reference numerals correspond to like elements throughout, and in which:

FIG. 1 is a side sectional view of the negative terminal end of a prior art electrochemical cell having a unitary seal and vent member;

FIG. 2 is a sectional side elevation view of the negative terminal end of an electrochemical cell in accordance with a preferred embodiment having independent vent and seal members; and

FIG. 3 is a sectional side elevation view of the negative terminal end of an electrochemical cell in accordance with an alternate embodiment having independent seal and vent members.

### DETAILED DESCRIPTION OF THE PREFERRED EMBODIMENTS

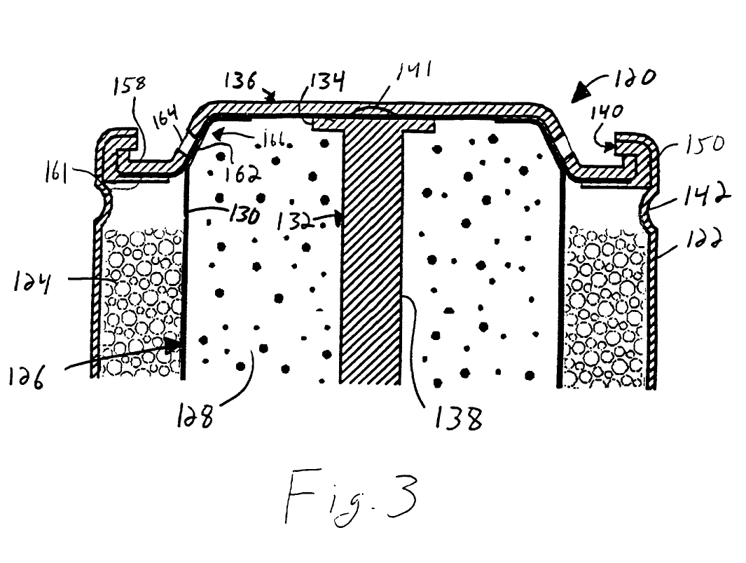

Referring now to FIG. 2, the negative terminal end 20 of an electrochemical cell constructed in accordance with a preferred embodiment of the invention includes an outer cylindrical steel container 22 that provides a positive current collector. A plurality, typically two to four, cylindrical annular cathode rings 24 (only one shown) is formed within the cell. Preferably, the outer diameter of rings 24 is greater than the inner diameter of the positive current collector 22 prior to installation, such that a pressure contact is formed between the outer walls of the rings 24 and the inner surface of container 22. Cathode rings 24 present a radially inner surface that defines a centrally disposed void 26.

Alternatively, the cathode rings 24 could have a diameter smaller than the inner diameter of container 22, such that the rings would be loosely placed inside the container and then forced to conform to the inner diameter of the container 22. In particular, a downward force is applied at the top surface of the uppermost ring, and a rod having a fixed outer diameter is disposed within the central aperture of the ring while the downward force is being applied. It has been discovered, however, that this alternate process of inserting and forming cathode rings 24 may cause the container 22 to stretch and expand somewhat.

A separator 30 is disposed radially inwardly of the inner surfaces of rings 24, and thus circumscribes the void 26. The void 26 is filled with an anode 28 that is mixed with electrolyte. Separator 30 comprises a non-woven, inert fabric that has sufficient porosity to enable permeability to gas and liquid such as an electrolyte, but substantially solid so as to prevent cathode 24 from electrically shorting with anode 28. Alternatively, separator 30 could be conformal, as is understood by those having ordinary skill in the art. Separator 30 prevents the anode 28 and cathode 24 from coming into physical contact with each other while permitting the flow of electrolyte therebetween. Separator 30 further ensures that any pressure buildup within the cell is distributed substantially equally within the cell. Anode 28 is generally cylindrically shaped, has an outer peripheral surface which engages the inner surfaces of separator 30, and comprises gelled zinc in accordance with the preferred embodiment.

The cathode 24 may comprise a mixture of manganese dioxide, MnO2, and a carbonaceous material, such as graphite, and is typically wetted with an alkaline electrolyte before being compressed into annular rings. The negative end 20 of the cell is sealed by an endplate 36 further presents the negative connection to the cell. A nail that comprises, for example brass, extends downstream from the endplate 36 and is in electrical contact with the anode 28 to provide negative current collector 32. Current collector 32 includes a head 34 that is in electrical contact with the endplate 36, and a substantially cylindrical body 38 extending axially downstream therefrom.

Alkaline cells of this type are described, for example, in U.S. Pat. No. 5,814,419 assigned to Rayovac Corporation, the disclosure of which is hereby incorporated by reference as is set forth in its entirety herein for the purposes of background information. It should be appreciated that the term “downstream” is used herein to indicate a direction from the negative end of the cell towards the positive end, while “upstream” is used to indicate a direction from the positive end of the cell towards the negative end.

A ridge 42 is formed in the inner surface of the steel container 22 proximal the negative end 20 of the cell, and provides a seat for an annular gasket 40. Gasket 40 is made of an elastomeric material or plastic in accordance with the preferred embodiment, and includes a hub 46 having an inner radial surface 44 that defines an inner diameter of the hub. The hub 46 thus enables the gasket 40 to seal against the outer diameter of current collector 32 upon installation, as will be described in more detail below. The hub 46 further presents a radially outer surface that defines a hub outer diameter. The gasket 40 further includes an annular sealing member 50 at its outer end that is disposed adjacent and radially inwardly of container 22. Outer member 50 extends axially upstream of the endplate 36 prior to the completion of cell the fabrication process. The outer member 50 presents a radially inner surface that defines an inner diameter of member 50.

The outer member 50 and hub 46 are connected via a gasket disk 48 that extends generally radially outwardly from the hub 46. In a direction radially outwardly from the hub 46, the disk 48 initially extends axially upstream at section 45, extends downstream at section 47, and then upstream again at section 59 prior to forming a flat radial surface 61 that joins disk 48 to outer member 50. The axial components of disk 48 provides flexibility to the disk in the radial direction, thereby enabling a spring constant to bias the hub 46 against the negative current collector 32 to form a tight seal, as will be described in more detail below.

The negative end 20 of the cell further includes a washer 52 that is disposed axially upstream of and adjacent the gasket 40. Washer 52 generally follows the contour of gasket 40, and includes an axially extending inner member 54 whose inner surface defines an inner diameter of the washer, and an annular axially extending outer member 56 whose outer surface defines an outer diameter of the washer. A washer disk 53 joins the inner and outer members 54 and 56, and slopes along with gasket disk 48 such that it comprises both radially and axially extending components to provide a spring force against the gasket 40. A flat radial surface 63 joins outer member 56 to washer disk 63, and sits on radial surface 61 of gasket 40. The radially inner surface of inner member 54 rests against the radially outer surface of hub 46. The radially outer surface of outer member 56 rests against the radially inner surface of outer member 50.

The outer diameter of the washer 52 is greater than the inner diameter of member 50, and the inner diameter of the washer 52 is less than the outer diameter of hub 46 prior to installation of the washer. Accordingly, the sloped disk 53 of washer further biases inner surface 54 against hub 46, thereby further sealing the hub against current collector 32. The outer member 56 of washer 52 also biases outer member 50 of gasket 40, thereby further sealing the outer member 50 against the container 22.

The endplate 36 has an annular outer radially extending flange 58 that sits on surface 63 of washer 52. Prior to installation of the current collector 32, endplate 36 is welded to flat surface 39 of current collector, using the weld projection 41 disposed thereon, as is well known in the art. The washer 52 is then fitted over the gasket 40, and the current collector 32 is driven through hub 46, creating a single assembly comprised of washer 52, gasket 40, current collector 32, and endplate 36. Because the hub 46 presents a smaller inner diameter with respect to the outer diameter of the current collector 32, a tight seal is formed therebetween that prevents the electrolyte and other fluids disposed in void 26 from escaping during normal operation of the cell.

The assembly is then installed into the container 22, already filled with active materials. The negative end of container 22, along with outer member 50 of gasket 40, is crimped over the outer flange 58 in the direction of arrow “A” so to retain the endplate 36 in position. FIG. 2 illustrates the container 22 and gasket 52 both before crimping 35, and after crimping 37. The crimping further biases the container against outer member 50, thereby improving the seal therebetween. The radial forces of the crimping are further transferred to the washer 52, whose inner member 54 is further biased against hub 46, thereby increasing the biasing spring force of hub against current collector 32 and tightening the resulting seal.

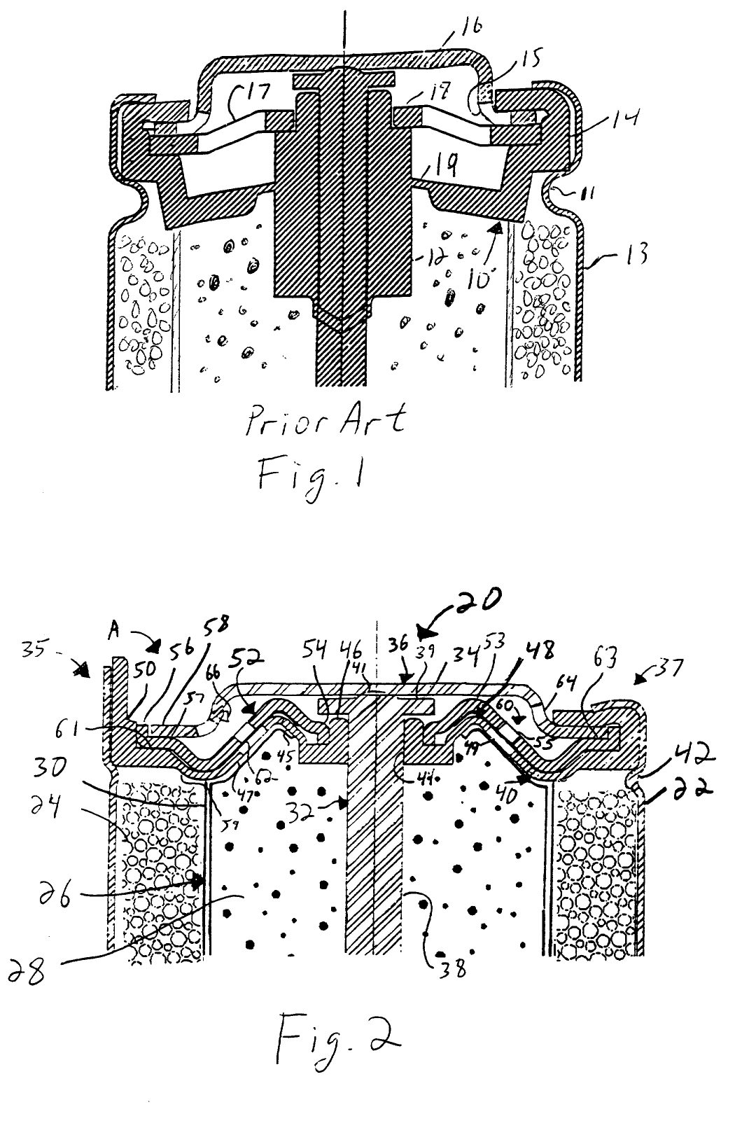

Advantageously, the forces provided by washer 52 provide a sufficiently strong seal between the hub 46 and current collector 32 so as to negate the need for an elongated hub, as in the prior art embodiment illustrated in FIG. 1. Accordingly, the space that was previously occupied by the inner hub of the gasket and prior art designs may now be occupied by active cell ingredients 28.

The cell further includes a vent 60 that enables pressurized cell ingredients (e.g., electrolyte and gas) to dissipate from the void 26 once a predetermined maximum pressure threshold has been reached. Advantageously, the vent 60 is separate from the sealing gasket 40. A pair of apertures 49 and 55 extends through the gasket and washer disks 48 and 53, respectively, and a third aperture 64 extends through the endplate 36. Apertures 49, 55, and 64 are aligned such that gas entering aperture 49 is able to travel through aperture 55 and exit the cell via aperture 64 during venting. Apertures 49, 55, and 64 thus permit the dissipation of pressure from within the cell once the internal cell pressure has exceeded a predetermined threshold, as will now be described.

In particular, a layer of film 62 is disposed between gasket 40 and washer 52, and is positioned such that it overlaps apertures 49 and 55. Film layer 62 is adhesively bonded to the inner surface of the gasket 40 at locations adjacent aperture 55 in accordance with the preferred embodiment to provide a direct blockage with respect thereto, but could alternatively be bonded to the outer surface of gasket 40. Alternatively, film layer 62 could be bonded to either the inner or outer surface of the washer 52 to provide a direct blockage with respect to aperture 49. The film 62 may comprise a 6-6 or 6-12 nylon in accordance with the preferred embodiment, or any suitable alternative material that is impervious to electrolyte attack (such as polypropylene, polyethylene, or polyolefin), and that is capable of stretching to providing a vent as described herein.

During normal operation, the film 62 prevents electrolyte from travelling through aperture 55 and out the cell. If internal cell pressure rises, however, the film 62 will begin to bow outwardly. Once the pressure exceeds the breaking point of the film 62, the film will rupture thus allowing the gasses and electrolyte that has traveled through the separator 30 and aperture 49 to further pass through aperture 55 and exit the cell via aperture 64. Vent 60 thus permits the safe dissipation of pressure within the cell once the pressure has exceeded a predetermined threshold. The threshold may be determined by the thickness of the film 62, may be further dependent upon whether the film has been pre-stretched prior to attachment. Advantageously, because no risk exists that the ruptured film 62 will block aperture 55, the void between endplate 36 and washer 52 is reduced with respect to the prior art, thereby further increasing the internal active cell volume.

The vent 60 may further include a nub 66 that extends downstream from the endplate 36 at a position aligned with the axis of extension of film layer 62. The nub 66 has a sufficiently sharp distal end that, when brought into contact with the film 62, will rupture the film thereby permitting the pressure to escape from the cell as described above. Alternatively, the nub may extend outwardly from washer 52, or any other suitable surface that would permit the film 62 to contact the nub after a significant amount of expansion only once the pressure within the cell has exceeded the maximum permissible threshold.

It should therefore be appreciated that the embodiment illustrated in FIG. 2 employs two separate components to provide a seal and a vent for an alkaline cell. Advantageously, the two components may be designed having properties compatible with their respective functions. For example, the film is ductile and will rupture only under predetermined conditions, while the gasket 44 may accept a significant spring force to provide a tight seal between itself and current collector 32 and container 22 without jeopardizing the integrity of the vent. The seal 60 furthermore occupies less space within the cell when compared with current designs, thus increasing the active volume within the cell and resulting in a longer usable life.

In particular, the cell illustrated in FIG. 2 in a AA size provides a total available internal volume of approximately 6,568 mm³, which is an increase in volume of approximately 7.6% over prior designs, thus significantly adding to the life of the battery. It should be easily appreciated to those having ordinary skill in the art that the present invention is equally applicable to other size cells, such as AAA, C, and D, which would present varying internal volumes and corresponding percentage increases in volume.

Referring now to FIG. 3, the negative terminal 120 of an electrochemical cell constructed in accordance with an alternate embodiment of the invention is illustrated having reference numerals corresponding to like elements of FIG. 2 incremented by 100 for the purposes of clarity and convenience. In accordance with this embodiment, the annular separator 130 is captured in position not only by the radially inner surface of cathode rings 124, but also by the inner surface of endplate 136. The outer flange 158 of endplate 136 is seated within a sealing gasket 140 prior to crimping. The gasket is supported by ridge 142. Once the gasket 140 and endplate are in place, the container 122 and outer member 150 are crimped as described above to capture the endplate 136 in position. The crimping additionally provides a tight seal at the interface between the gasket 140 and endplate 136, and between the gasket and container 122. Because the gasket 122 is used only to seal the endplate 136 and container 122, it need not extend radially inwardly of separator 130 as in the embodiment illustrated in FIG. 2. Additionally, the current collector 132 is entirely captured within the void 126 and self-sealed at the endplate 136. Accordingly, no seal is needed at the current collector with respect to the anode mixture 128, and therefore no washer is present in accordance with this embodiment.

The vent 166 is provided that, as described above, is separate from the sealing gasket 140. In particular, a layer of film 162 is attached to the inner surface of endplate 136 and spans from a location radially inwardly of aperture 164 to a location radially outwardly of aperture 164. Preferably, the layer 162 is disposed between the separator 130 and the endplate 136 such that the radially outer end of layer 162 is secured to flange 158, while the radially inner end is attached to the radially extending surface of endplate 136. While the film layer 162 is adhesively bonded to the endplate 136 in accordance with this embodiment, it should be appreciated that any suitable alternative fastening mechanism could be used. Because the film covers aperture 164, gasses and liquids are prevented from escaping from the cell during normal use. If, however, that cell is misused such that a significant amount of pressure builds within the cell, the film 162 will expand outwardly, and will rupture when the pressure within the cell exceeds the predetermined threshold, thus allowing dissipation from the cell to the ambient environment through aperture 164.

Because the only seal that is necessary in this embodiment is disposed at adjacent the endplate 136, the entire interior cavity 126 of the cell defined by the endplate 136 and separator 130 is sealed and may therefore be filled with active cell ingredients. As a result, the active volume within the cell is further increased to 6102 mm³, or approximately 12% greater than the conventional alkaline cells having a unitary seal/vent member.

It should be appreciated that while film 162 directly provides a blockage with respect to aperture 164 in accordance with the embodiment illustrated in FIG. 3, film 62 also provides a blockage with respect to aperture 64 (in FIG. 2) by preventing anode material and gas from entering the cavity defined by endplate 36 and washer 52 and escaping from the cell via aperture 64. Accordingly, the present invention provides a vent that is closed so as to block an aperture extending through the endplate only when the internal cell pressure is below a predetermined threshold, and that opens to allow pressurized internal cell ingredients to escape from the cell when the internal pressure has exceeded the predetermined threshold.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements included within the spirit and scope of the invention, as set forth by the appended claims.

We claim:

1. An electrochemical cell comprising:
a cylindrical container having an axially extending sidewall;
a cathode disposed within the sidewall having an inner surface that defines a centrally disposed void filled with internal cell ingredients;
an endplate connected to the container, wherein the endplate defines an aperture extending therethrough;
an ionically permeable separator interposed between the cell ingredients and the cathode;
a negative current collector at least partially disposed within the void and electrically connected to the cell ingredients, the current collector having a distal end that is connected to the endplate;
a compressed seal member disposed between the endplate and container, wherein the seal prevents the cell ingredients from flowing therebetween; and
a vent member separate from the seal member providing a blockage to the aperture, wherein the vent opens when an internal cell pressure has exceeded a predetermined threshold.

2. The cell as recited in claim 1, wherein the seal member comprises a gasket.

3. The cell as recited in claim 2, wherein the seal is a plastic.

4. The cell as recited in claim 2, wherein the seal is an elastomer.

5. The cell as recited in claim 2, wherein the seal comprises nylon.

6. The cell as recited in claim 2, wherein the container and gasket are crimped over the endplate.

7. The cell as recited in claim 1, wherein the vent member comprises a layer of film connected to an inner surface of the endplate so as to extend over the aperture.

8. The cell as recited in claim 7, wherein the vent member is made of a nylon material.

9. The cell as recited in claim 2, wherein the gasket further extends radially inwardly, and includes a hub that surrounds the negative current collector.

10. The cell as recited in claim 9, wherein the gasket defines a second aperture extending therethrough and in communication with the aperture of the endplate, further comprising a layer of film extending across the second aperture.

11. The cell as recited in claim 9, further comprising a washer having an inner and outer end that bias the gasket against the current collector and container, respectively.

12. The electrochemical cell as recited in claim 11, wherein the washer further defines a second aperture extending therethrough and in communication with the aperture of the endplate, further comprising a layer of film extending across the second aperture.

13. An electrochemical cell comprising:
a cylindrical container having an axially extending sidewall;
a cathode disposed within the sidewall having an inner surface that defines a centrally disposed void filled with internal cell ingredients;
an endplate connected to the container, wherein the endplate defines a first aperture extending therethrough;
an ionically permeable separator interposed between the cell ingredients and the cathode;
a negative current collector at least partially disposed within the void and electrically connected to the cell ingredients, the current collector having a distal end that is connected to the endplate;
a compressed elastomeric gasket having an outer end disposed between the endplate and container, and having an inner hub connected to the current collector, wherein the gasket defines a second aperture extending therethrough;
a washer disposed adjacent the gasket providing a spring force that biases the inner hub against the current collector and that further biases the outer end against the container, wherein the washer defines a third aperture extending therethrough; and
a film extending across the second aperture, wherein the film ruptures when an internal cell pressure exceeds a predetermined threshold.

14. The electrochemical cell as recited in claim 13, wherein the film bows outwardly under pressure, the cell further comprising a nub that engages the bowed film to rupture the vent.

15. The electrochemical cell as recited in claim 13, wherein the gasket and washer further comprise radially and axially extending components.

16. The electrochemical cell as recited in claim 13, wherein the container and gasket are crimped over the endplate.
